(19) United States
(12) Patent Application Publication
(10) Pub. No.: US 2010/0264230 A1
(43) Pub. Date: Oct. 21, 2010

(54) Severe storm / hurricane modification method and apparatus

(76) Inventor: David B. Romanoff, New London, NH (US)

Correspondence Address: MESMER & DELEAULT, PLLC, 41 BROOK STREET, MANCHESTER, NH, 03104, US

(21) Appl. No.: 12/425,793

(22) Filed: Apr. 17, 2009

(51) Int. Cl. A01G 15/00

(52) U.S. Cl. 239/2.1

(57) ABSTRACT

A method and apparatus for weakening a storm uses liquid or solid nitrogen. In one embodiment, the method includes the steps of providing liquid nitrogen enclosed within at least one container, dropping the container into a storm, and dispersing the liquid nitrogen from the container starting at the top of the storm, whereby the nitrogen cools and therefore weakens the storm. In another embodiment, the method includes the steps of providing solid nitrogen pieces each sized to melt and evaporate in the time it takes to fall from the top of a storm along a major portion of the height of the storm and dropping the solid nitrogen pieces into a storm, whereby the melting and evaporating nitrogen cools and therefore weakens the storm.

### BACKGROUND OF THE INVENTION

1. Field of the Invention

The invention relates to methods of weather control by dispersing a substance from a vehicle such as an aircraft, and apparatuses used therewith.

2. Description of the Related Art

Storms such as tropical cyclones and “hurricanes” need the warm water of the tropics, which feed the storms with energy. In a mature hurricane, the wind picks up warmth and moisture from the ocean, circling inward ever faster from outer cloud bands to the inner eye wall, where the winds are the strongest and where it finally rises rapidly and is pushed out the top.

Most hurricanes that hit the United States begin either in the Caribbean Sea or the Atlantic Ocean. Many of the worst storms start as seedlings coming off the west coast of Africa.

In the beginning, a disturbance forms in the atmosphere, developing into an area of low atmospheric pressure. Winds begin to move into the center of the storm seedling from surrounding areas of higher air pressure. Warm water heats the air, and it rises as it nears the center.

The ocean feeds warmth and moisture into the storm, providing energy that causes the warm air in the center to rise faster. It condenses high in the atmosphere, creating thunderstorms. The tropical depression develops (if conditions are favorable) into a tropical storm, and then finally into a hurricane, which is not unlike a giant swirling mass of thunderstorms.

As rising air in the storm's center condenses, it produces heat, forcing it to rise even faster. The air is pushed out the top, much like smoke out of the chimney of a fire. Then more air has to rush in at the surface to take its place. This agitates the ocean more, and in this way the storm essentially feeds on itself.

While many factors control the number of hurricanes in a given season, the long-term trend is strongly influenced by a type of “conveyor belt” that moves Atlantic Ocean water northward from near the Caribbean to an area east of Greenland.

There, the current sinks deep, moves southward, and flows into the southern Atlantic Ocean and beyond. It is this warm, northward-moving surface water that helps produce the strongest storms. It is fuel for any hurricane.

The air in a hurricane's center or eye is always warm relative to its surroundings, and this is what makes hurricanes a unique type of atmospheric vortex in the tropics. Hurricanes are also referred to as tropical cyclones. Outside the tropics, in the midlatitudes, giant storms which bring everyday weather to the United States (called extratropical cyclones) contain cold air in their center, and typically do not feature anything that resembles a clear eye like the hurricane.

In the eye of the hurricane, the warmest air occurs at high levels, higher than five or six miles above the surface. Here, the temperature is commonly ten degrees Fahrenheit warmer than surroundings, and can approach 15 or even 20 degrees in the most intense hurricanes. The warm air has its origins in the energy contained in the uppermost layer of seawater. The hot tropical sun warms the ocean surface to values exceeding about 80 degrees Fahrenheit. The warm seawater readily evaporates. When liquid water evaporates, it turns into gaseous form. This change of phase requires an energy input, namely, the heat contained in the ocean. The water vapor extracts ocean heat, then rises and condenses inside giant thunderclouds surrounding the hurricane vortex. Condensation is the opposite of evaporation. When the vapor turns back into liquid (in the form of cloud droplets and rain), the heat energy gets released into the air. The warm air high up in the clouds is retained inside the swirling vortex of winds, which causes the core of the hurricane to warm up. In addition, with air rising inside the eye wall clouds, there must be some compensation, in the form of air sinking inside the eye. When air descends from great heights, it compresses and warms. This process adds further warmth to the inside of the eye.

Thus, air sinking inside the eye and heat released by eye wall clouds during condensation creates a warm hurricane core. The warm air in the eye powers the hurricane. Most materials expand when heated. In the eye of the hurricane there is a vertical column of air stretching from storm top to ocean surface. When the air column is warmed from the aforementioned processes, it expands vertically. Since air pressure decreases with height, air with lower pressure essentially moves downward, closer to the ocean surface, from above. Thus, the surface pressure inside the eye decreases, causing air to flow inward toward the center of the storm from the higher-pressure surroundings. The inflow of wind gets deflected into a counterclockwise spiral (in the northern hemisphere) due to the Earth's rotation and generates the swirling winds of the hurricane. The lower pressure in the eye of the hurricane also causes the level of the sea to rise within the eye compared to outside of the eye, which is responsible for the storm surge when the hurricane hits land.

Using a simple analogy, the hurricane behaves like a “heat engine” similar to the engine in an automobile. In a car engine, combustion occurs in cylinders inside the engine. The cylinders spin the engine. Gasoline is burned inside the cylinders, giving rise to a tremendous amount of heat, and this heat does the work of spinning the engine components. In a hurricane “engine”, the cylinders are the giant clouds surrounding the eye. The “fuel” is water vapor, and instead of combustion, there is condensation. Heat is released inside the storm warming the hurricane “engine”. Through the mechanism described above, the heat energy in the eye lowers the surface pressure, which acts to accelerate the winds into a spinning vortex.

One can put one's hand on the hood of a car, and by feeling how hot the hood is, one can get some sense for how fast the engine is running. But in hurricanes, the top of the “heat engine” is often obscured by clouds. One cannot directly observe how “fast” the storm is operating from space, that is, how strongly the winds are blowing. But government agencies have found a way to drop small, instrumented devices inside the eye of a hurricane, using a high altitude research aircraft that flies above the storm. These “dropsondes” measure the temperature of the hurricane eye. The warmer the air, the faster the winds beneath rotate. Government agencies also have satellites that can detect the heat by penetrating through clouds, using microwave energy, and scientists are finding that a good correlation exists between the temperature inside the hurricane eye and the intensity of the storm.

One method of modifying or weakening a storm such as a hurricane is to lower the surface temperature to stall the heat engine. This method that has been disclosed in U.S. Pat. App. Pub. No. 2002/0008155A1 by Uram, which was published on Jan. 24, 2002. Uram teaches the use of one or more nuclear submarines to pump cool water from ocean depths to the ocean surface. This method would be very expensive to try, since it would require building or modifying government naval warfare equipment costing billions of dollars.

Another method is disclosed in PCT Pat. App. Pub. No. WO 2008/030601A2 by Wright, which was published on Mar. 13, 2008. Wright teaches a method for reducing storms or hurricanes using a wind powered pump instead of a nuclear submarine to pump cool water from the ocean depths to the surface. Although this would save the cost of providing specially modified nuclear submarines, it is difficult to believe the method would work as presented given the raging seas and destructive winds surrounding and inside a hurricane. The apparatus proposed may not survive long enough to operate as intended.

Yet another system that has been disclosed in U.S. Pat. App. Pub. No. 2007/0158449A1 by Hoffman et al., which was published on Jul. 12, 2007. Hoffman et al. teach dispersing liquid oxygen, nitrogen, or hydrogen at great force from an aircraft onto the top of the eye wall of a hurricane to cool and weaken it. By dispersing the liquid coolant from the aircraft with great force, they hope to cool the eye wall top to bottom. Hoffman et al. admit that there are dangers to the aircraft crew using compressed explosive hydrogen and oxygen in an aircraft. Plus, the mechanism for dispersing the coolant directly from the aircraft to the storm is not well explained. Therefore, what is needed is a method and apparatus for weakening a storm that can be accomplished with available technology and will operate in a hurricane environment.

### SUMMARY OF THE INVENTION

It is an object of the present invention to greatly reduce the cost of a severe storm such as a hurricane in terms of loss of property and loss of life. This is achieved by weakening the storm. It is an object of the present invention to provide a method and apparatus that can cool a storm sufficiently to weaken it. It is a further object of the present invention to use existing technology that can operate in hurricane conditions.

In one embodiment, the present invention achieves these and other objectives by providing a method that includes providing liquid nitrogen enclosed within at least one container, dropping the container into a storm, and dispersing the liquid nitrogen from the container starting at the top of the storm, whereby the nitrogen cools and therefore weakens the storm by interfering with the storm's heat engine.

In another embodiment, the present invention provides a method that includes providing solid nitrogen pieces each sized to melt and evaporate in the time it takes to fall from the top of a storm along a major portion of the height of the storm and dropping the solid nitrogen pieces into the storm, whereby the melting and evaporating nitrogen cools and therefore weakens the storm.

In still another embodiment, the present invention provides a method that includes serially dropping a plurality of containers filled with a pre-measured quantity of liquid or solid nitrogen from an aircraft into an eye or eye wall of the hurricane wherein a major portion of the height of the hurricane is provided with a linear array of the serially dropped plurality of containers, and substantially simultaneously releasing the pre-measured quantity of liquid nitrogen from the plurality of containers thereby interfering with the heat engine of the hurricane and weakening the hurricane.

In the embodiments where one or more containers are used, the containers may release the nitrogen by activating a switch based on one or more properties such as, for example, pressure, radar, time, remote control, and/or GPS.

These and other features, aspects, and advantages of the present invention will become better understood with regard to the following description, claims, and accompanying drawings.

### BRIEF DESCRIPTION OF THE DRAWINGS

FIG. 1 is a representation of the method of the present invention being carried out.

FIG. 2 is a schematic view showing some details of a means for dispersing liquid nitrogen according to the present invention.

FIG. 3 is a process flow chart of the method of the present invention.

FIG. 4 is a process flow chart of the embodiment that uses solid nitrogen.

### DETAILED DESCRIPTION OF THE PREFERRED EMBODIMENT

One embodiment of the invention is a method of weakening a storm comprising the steps of providing liquid nitrogen enclosed within one or more containers; dropping the one or more containers into a storm, the storm having a top; and dispersing the liquid nitrogen from the container starting at the top of the storm, whereby the nitrogen cools and therefore weakens the storm. Because the storm becomes weaker, its cost to society is lower in terms of loss of property and loss of life.

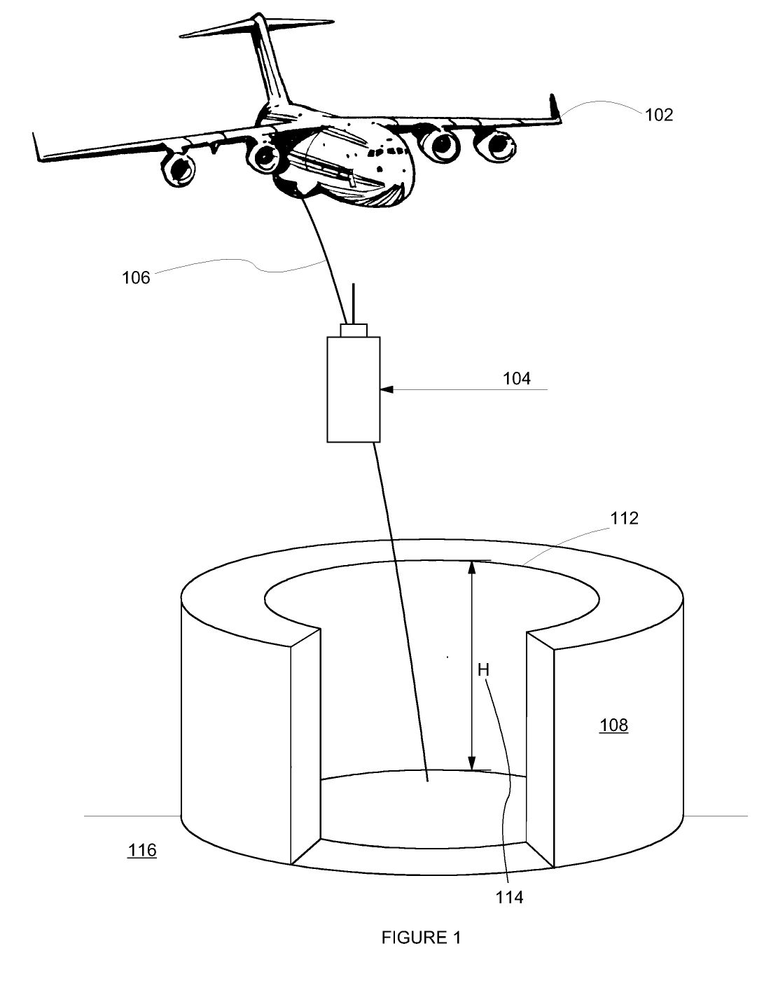

The preferred embodiment(s) of the present invention is illustrated in FIGS. 1-4. Turning to FIG. 1, there is illustrated for purposes of explaining the present invention, which illustration is not to scale, a storm 108 over the earth 116. References to the surface of the earth 116 are understood to include the ground and sea. Also, references to a storm 108 include but are not limited to a hurricane. An eye wall 112 of a hurricane is illustrated to define the inside of the storm.

In the embodiment shown in FIG. 1, liquid nitrogen is provided enclosed within a container assembly 104. The container assembly 104 is delivered by an aircraft 102, for example, by dropping it inside a hurricane 108 eye wall 112. It is well known that airplanes can fly over storms in general and hurricanes in particular. It is also known that they can drop objects such as dropsondes into the eye. Other aircraft besides airplanes could be used so long as they are capable of flying at an altitude greater than the storm.

Container assembly 104 is configured to begin dispersing the liquid nitrogen at a selected altitude “H” 114 over the surface of the earth 116 with a dispersing means. Altitude “H” represents the height of the storm. The nitrogen is preferably dispersed continuously down from the top of the storm to the earth's surface to cool the storm and thereby reduce its intensity and damage it causes. It is contemplated that a plurality of container assemblies 104 are dropped serially from the aircraft 102 into the eye wall 108 or into the eye adjacent the eye wall 108. Each container 104 is equipped with a triggering mechanism to release its cargo of liquid nitrogen or solid nitrogen at a predetermined height so that the liquid or solid nitrogen is released substantially simultaneously along a major portion of the height of the storm. This substantially simultaneous release along a major portion of the height of the storm is designed to interrupt the heat engine sufficient to weaken the hurricane from, for example, a category 4 to a category 1 or 2. By reducing the intensity of the hurricane before the hurricane makes landfall would significantly reduce the amount and cost of the damage caused by the winds and storm surge of the hurricane. The release or triggering mechanism may be effected using a number of devices and methods. These mechanisms are explained later.

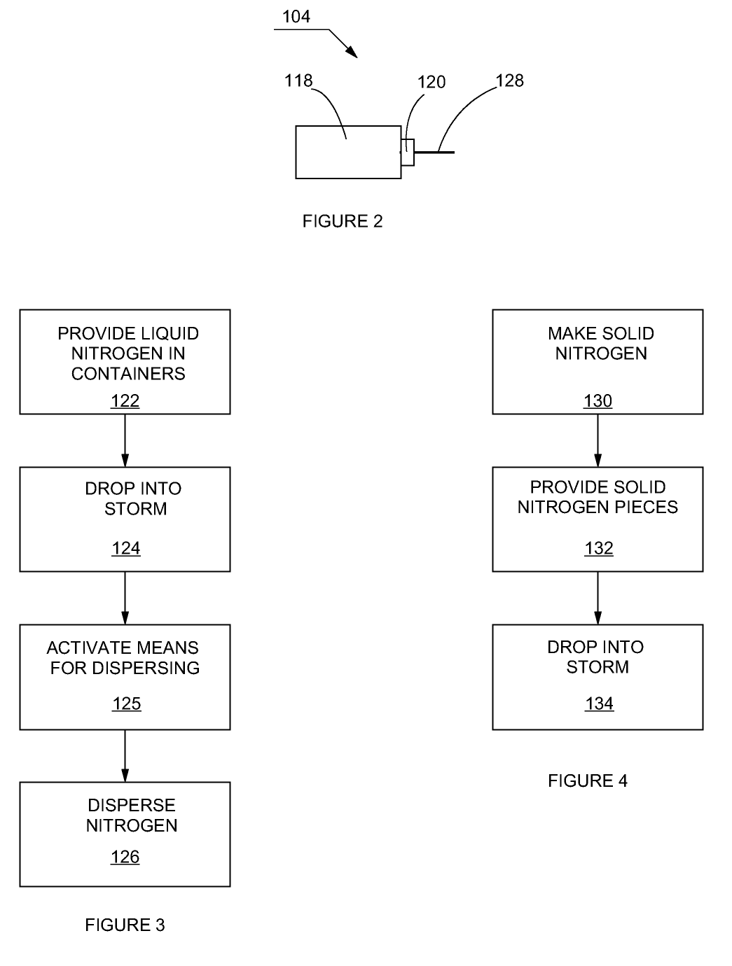

FIG. 2 symbolically shows one embodiment of the container assembly 104 capable of enabling the dispersion of liquid or solid nitrogen at the desired altitude “H” 114. The container assembly 104 includes a container 118, dispersing activating means 120, and a dispersing means 128. The container 118 is preferably a pressurized gas cylinder, although other containers could be used.

The dispersing activating means 120 is preferably a switch that is activated by one or more means or properties such as, for example and without limitation, barometric pressure, radar, time, remote control, or altitude. Altitude can be measured using pressure, radar or GPS.

The dispersing means 128 for dispersing the liquid nitrogen from the container may include a) a port in communication with the container capable of dispersing liquid or gaseous nitrogen; b) a rupture disc in communication with the container, the rupture disc selected so that it ruptures at a selected altitude “H” 114 above the surface of the earth 116 as determined by barometric pressure; or c) a releasable, multipart container that separates upon activation of a release mechanism that disengages one or more retaining members that hold the multipart container together (not shown). Where a port is used, the port can be a tube, valve, nozzle, or even a hole in the container.

FIG. 3 is a process flow chart showing the steps of the method of modifying and weakening a severe storm or hurricane. First, liquid nitrogen is provided enclosed within at least one container 104 at step 122. The amount of liquid nitrogen (and conversely the number of containers 104) required is calculated by the height of the major portion of the storm that is to be cooled to modify or weaken the storm. One of the goals of the present invention is to disrupt the flow of air within the storm as the storm nears landfall so that it becomes less organized and therefore less powerful, which means less damage caused by the winds and storm surge.

At step 124, the containers 104 of liquid nitrogen are dropped, preferably in a serial release, into the storm 108 by an aircraft 102. When the containers 104 are delivered to a selected altitude over the surface of the earth within the storm, the means for dispersing the liquid nitrogen are activated at step 125. The serial release of the plurality of containers 104 is timed to provide a plurality of the containers 104 that are linearly dispersed along the height “H.” The linear array of containers 104 along the height “H” of the storm provides for a substantially simultaneous activation that occurs at by step 125. At step 126, the nitrogen is rapidly dispersed 126 from the plurality of containers 104 substantially simultaneously so that nitrogen is released from the top of the storm down to the surface of the earth. The nitrogen leaving the container assembly could be a gas, a liquid, or a mixture. The liquid nitrogen warms to its boiling point, thereby absorbing some energy, and then boils at a temperature much cooler than the atmosphere, which is the primary energy absorption mechanism. The nitrogen absorbing some of the heat energy within the storm cools the storm, interrupts the heat engine and weakens the storm.

Liquid nitrogen is a readily available industrial chemical. Using nitrogen has the benefit of not being a greenhouse gas, is non-polluting, non-toxic, and inexpensive. Molecular nitrogen makes up 78% of the earth's atmosphere by volume. Liquid nitrogen in a container, depending on its temperature, tends to boil continuously. Therefore, users must provide for safely venting the nitrogen to prevent unsafe pressures from building up inside the containers. Although molecular nitrogen is inert at atmospheric conditions, it can become dangerous to humans if it displaces oxygen within a confined space, such as an aircraft cabin. Any nitrogen released from the containers from boiling off or pressure relief must be safely vented overboard.

Another embodiment of the present invention involves using solid nitrogen pieces instead of liquid nitrogen. The benefit of using solid nitrogen is that it does not have to be dispersed from a container as it is falling through a storm. The solid nitrogen can simply be dropped without a container over a storm and then melt and vaporize as it falls.

Turning to FIG. 4, there is illustrated a flow chart involving the use of solid nitrogen. Beginning at step 130, solid nitrogen is made from either liquid or gaseous nitrogen. Molecular nitrogen liquefies at −196 degrees C. Molecular nitrogen solidifies only 14 degrees cooler at −210 degrees C. Solid nitrogen can be made, for example, by contacting it with a liquid having a lower freezing temperature such as liquid helium.

The solid nitrogen should be made as substantially uniform pieces or processed, such as by crushing, into substantially uniformly sized pieces at step 132. The required size of the pieces can be calculated. To calculate the required size, the user would determine the height of the storm into which the pieces will be dropped. Then a user would have to perform a series of mathematical iterations between 1) a ballistics calculation of the terminal velocity of the solid nitrogen piece, and 2) a thermodynamic calculation of the heat absorption of the piece at the terminal velocity that would result in the piece completely melting and vaporizing just as it is reaching the desired altitude. The result of the iterations would be the required solid nitrogen piece size.

In operation, a solid nitrogen manufacturing facility would make solid nitrogen 130 near an airport as a selected storm is approaching. The solid nitrogen could be formed in ice cube trays of the desired and/or required size or in a continuous ice-making process. The solid nitrogen pieces would therefore be provided in a particular size at step 132. The solid nitrogen pieces would then be loaded into an aircraft and preferably kept below its boiling temperature in one or more containers with suitable insulation. This minimizes or eliminates the need to vent off boiling nitrogen from inside the aircraft. The nitrogen is then flown over a storm while the nitrogen is still below its boiling temperature. The solid nitrogen is dropped into the storm 134 without any containers, which saves the cost of containers with specific release mechanisms.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A method of weakening a storm comprising the steps of:
providing liquid nitrogen enclosed within at least one container;
dropping the container into a storm from a top of the storm; and
dispersing the liquid nitrogen from the container starting at the top of the storm and along a major portion of the height of the storm, whereby the nitrogen interferes with the heat engine of the storm by absorbing heat and therefore weakens the storm.

2. The method of claim 1 further comprising the step of activating a means for dispersing the liquid nitrogen when the container is at the top of a storm.

3. The method of claim 2 wherein the means for dispersing is activated by one property selected from the group consisting of barometric pressure, radar, time, remote control, and GPS.

4. The method of claim 2 wherein the means for dispersing is a port in communication with the containers capable of dispersing liquid or gaseous nitrogen.

5. The method of claim 1 wherein the dropping step is performed from an aircraft.

6. The method of claim 1, wherein the dispersing step is performed substantially over the entire height of the storm.

7. A method of weakening a storm comprising the steps of:
providing solid nitrogen pieces each sized to melt and evaporate in the time it takes to fall from the top of a storm along a major portion of the height of the storm; and
dropping the solid nitrogen pieces into a storm, whereby the melting and evaporating nitrogen interferes with the heat engine of the storm and therefore weakens the storm.

8. The method of claim 7, further comprising the step of making solid nitrogen with liquid helium.

9. The method of claim 7, wherein the dropping step is performed from an aircraft.

10. A method of weakening a hurricane comprising:
serially dropping a plurality of containers filled with a pre-measured quantity of liquid or solid nitrogen from an aircraft into an eye or eye wall of the hurricane wherein a major portion of the height of the hurricane is provided with a linear array of the serially dropped plurality of containers; and
substantially simultaneously releasing the pre-measured quantity of liquid nitrogen from the plurality of containers thereby interfering with the heat engine of the hurricane and weakening the hurricane.

11. The method of claim 10 wherein the releasing step is enabled based on a property selected from the group consisting of barometric pressure, radar, time, remote control, and GPS.

12. The method of claim 10 wherein the releasing step includes opening a port on each of the plurality of containers.

13. The method of claim 10 wherein the releasing step includes rupturing a rupture disc on each of the plurality of containers.

14. The method of claim 10 wherein the releasing step includes activating a release switch using a property selected from the group consisting of barometric pressure, radar, time, remote control, and GPS.

15. The method of claim 10 wherein the plurality of containers are each a multipart container and wherein the releasing step includes using a releasing mechanism that disengages one or more retaining members that hold the multipart container together.
